(19) United States
(12) Patent Application Publication
(10) Pub. No.: US 2017/0234252 A1
(43) Pub. Date: Aug. 17, 2017

(54) ENGINE CONTROLLER

(71) Applicant: MAZDA MOTOR CORPORATION, Hiroshima (JP)

(72) Inventors: Yasunori UESUGI, Hiroshima-shi (JP); Hiroshi MINAMOTO, Hiroshima-shi (JP); Kenko UJIHARA, Higashihiroshima-shi (JP); Yoichi FUJIOKA, Higashihiroshima-shi (JP)

(73) Assignee: MAZDA MOTOR CORPORATION, Hiroshima (JP)

(21) Appl. No.: 15/421,993

(22) Filed: Feb. 1, 2017

(30) Foreign Application Priority Data
Feb. 12, 2016 (JP) 2016-025048
Feb. 12, 2016 (JP) 2016-025056

(51) Int. Cl. F02D 41/10; F02D 41/14; F02D 41/40; F02D 41/00; F02D 41/26

(52) U.S. Cl. CPC F02D 41/10; F02D 41/005; F02D 41/0077; F02D 41/26; F02D 41/401; F02D 41/1454; F02D 2200/1004; F02D 2200/602

(57) ABSTRACT

The engine controller includes an acceleration input detector that detects an accelerator pedal motion, a fuel injection amount calculator that calculates a target fuel injection amount, a fuel injection controller that controls the fuel injector, an EGR valve opening calculator that calculates a target EGR valve opening, and an EGR controller that controls the EGR valve. The EGR controller controls, after the accelerator pedal motion has been given, the EGR valve in a direction to decrease an opening of the EGR valve to a target EGR valve opening corresponding to a running condition to be reached after the accelerator pedal motion has been given. The control of the EGR valve opening is started before the fuel injection controller controls the fuel injector based on the target fuel injection amount calculated by the fuel injection amount calculator based on the accelerator pedal motion.

### TECHNICAL FIELD

The present invention relates to an engine controller, and more particularly to an engine controller that improves acceleration response and also achieves low emission performance.

### BACKGROUND ART

Diesel engines equipped with a turbocharger has been developed to improve acceleration performance. Such kind of diesel engines tend to emit smoke when accelerating at a low accelerator position where turbocharging delay causes a temporary lack of oxygen in a combustion chamber.

A technique for solving the problem is disclosed in Japanese Patent Application Laid-Open No. 2008-240682 (referred to as Patent Literature). Patent Literature discloses a diesel engine controller including a fuel injection limiter that sets an upper limit of fuel injection amount and limits the fuel injection amount within the upper limit. The fuel injection limiter sets the upper limit to the leaner side at a low accelerator position compared to a high accelerator position.

The controller including the fuel injection limiter keeps the fuel injection amount sufficiently low when the diesel engine accelerates at a low accelerator position where the lack of oxygen tends to happen, and thereby minimizes smoke by setting the upper limit of the fuel injection amount to the leaner side compared to a high accelerator position.

The controller disclosed in Patent Literature capable of minimizing smoke however might disadvantageously deteriorate acceleration response by limiting the fuel injection amount. For example, when an acceleration command (given by a push-in amount or a push-in speed of an accelerator pedal) requires a fuel injection amount exceeding the upper limit, the fuel injection amount is fixed at the upper limit regardless of any change in the acceleration command, thereby keeping the vehicle acceleration unchanged. The driver might feel that the vehicle acceleration is not responding to the push-in amount and the push-in speed of the accelerator pedal and cannot enjoy the feeling of maneuvering the vehicle.

In some cases, turbocharging is limited by the performance of the turbocharger and the vehicle acceleration will not respond to the push-in amount, for example, of the accelerator pedal, causing the same problem.

### SUMMARY OF INVENTION

The present invention is made in view of the abovementioned problem. An object of the present invention is to provide an engine controller that can provide improved acceleration response and also achieve low emission performance.

The present invention provides an engine controller for controlling, based on a running condition of a vehicle, an engine including an EGR device that includes an EGR passage for recirculating exhaust gas in an exhaust passage to an intake passage and an EGR valve for adjusting a flow rate of exhaust gas flowing through the EGR passage, and a fuel injector that injects fuel in a cylinder. The engine controller includes an acceleration input detector that detects an accelerator pedal motion, a fuel injection amount calculator that calculates a target fuel injection amount based on a running condition of the vehicle including the accelerator pedal motion and oxygen in an intake air to be introduced in the cylinder, a fuel injection controller that controls the fuel injector such that an amount of fuel injected by the fuel injector is the target fuel injection amount, an EGR valve opening calculator that calculates a target EGR valve opening based on the running condition, and an EGR controller that controls the EGR valve such that an opening of the EGR valve is set to the target EGR valve opening. The EGR controller starts controlling the EGR valve in a direction to decrease the opening of the EGR valve to the target EGR valve opening corresponding to a running condition to be reached after the accelerator pedal motion has been given, the controlling of the EGR valve being started after the accelerator pedal motion has been given but before the fuel injection controller controls the fuel injector based on the target fuel injection amount calculated by the fuel injection amount calculator based on the accelerator pedal motion.

### BRIEF DESCRIPTION OF DRAWINGS

FIG. 1 is a schematic diagram of an engine system using an engine controller according to an embodiment of the present invention;

FIG. 2 is a block diagram illustrating an electric scheme of the controller;

FIG. 3 is a flowchart of engine control processing performed by the controller;

FIG. 4 is a map schematically illustrating an operating region where a large turbocharger and a small turbocharger selectively work;

FIG. 5 schematically illustrates a change in a fuel injection amount in the engine and a fuel injection amount guard value;

FIG. 6 illustrates characteristics of the engine according to the embodiment and an engine according to Comparative Example 1, where chart (a) illustrates the change in a vehicle speed, chart (b) illustrates the change in accelerator position, chart (c) illustrates the change in NOx emission, chart (d) illustrates the change in a fuel injection amount, chart (e) illustrates the change in oxygen concentration in intake air, chart (f) illustrates the change in a charged air amount, chart (g) illustrates the change in EGR valve opening, and chart (h) illustrates the change in a rotational speed of a turbocharger;

FIG. 7 schematically illustrates an acceleration profile of the engine according to the embodiment;

FIG. 8 illustrates characteristics of the engine according to the embodiment, where chart (a) illustrates the change in the accelerator position, chart (b) illustrates the change in the fuel injection amount, chart (c) illustrates the change in a turbocharging pressure, and chart (d) illustrates the change in the EGR valve opening;

FIG. 9 illustrates characteristics of an engine according to Comparative Example 2, where chart (a) illustrates the change in the accelerator position, chart (b) illustrates the change in the fuel injection amount, chart (c) illustrates the change in the turbocharging pressure, and chart (d) illustrates the change in the EGR valve opening; and

FIG. 10 schematically illustrates a valve opening map for setting the EGR valve opening.

### DESCRIPTION OF EMBODIMENTS

A preferable embodiment of the present invention will now be described with reference to the attached drawings.

### System Configuration

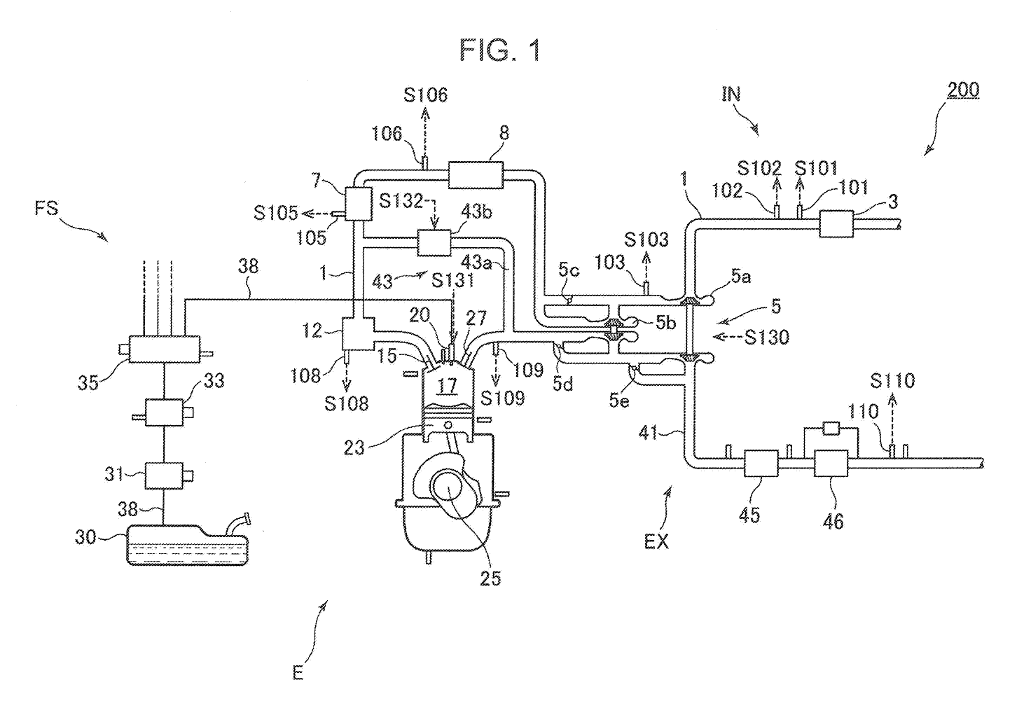

An engine system using an engine controller according to an embodiment of the present invention will now be described with reference to FIG. 1.

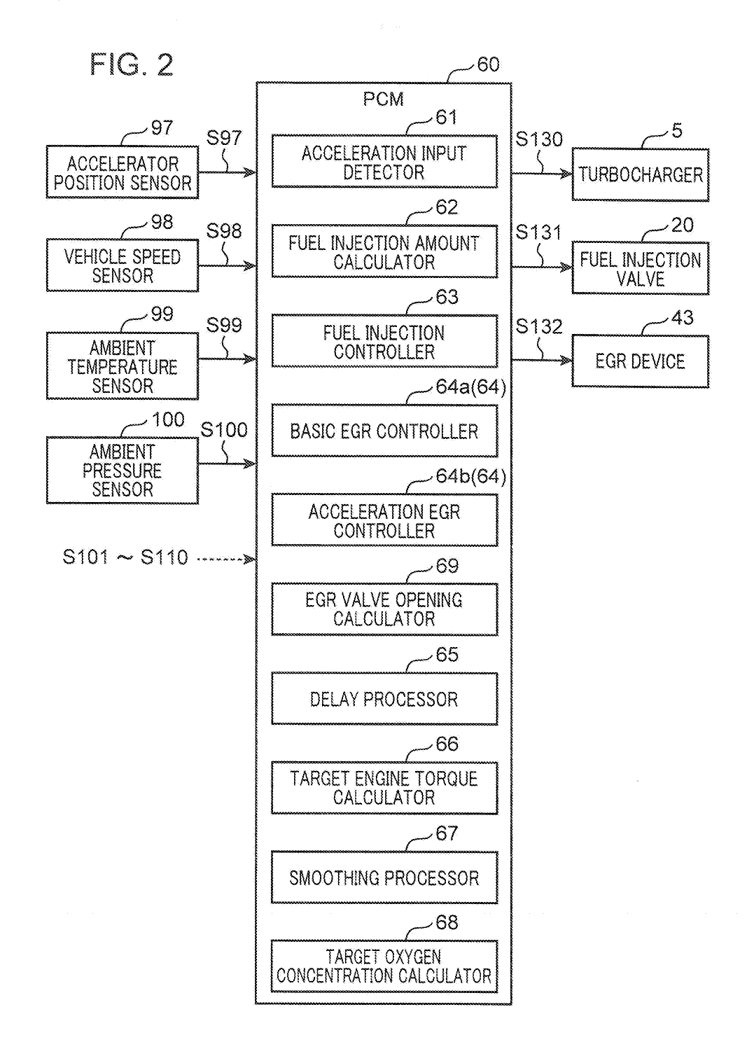

As illustrated in FIG. 1, an engine system 200 includes a diesel engine E (hereinafter referred to as an engine E), an intake system IN for taking air into the engine E, a fuel supply system FS for supplying fuel to the engine E, an exhaust system EX for discharging exhaust gas from the engine E, sensors 97 to 110 that detect conditions in the engine system 200, and a power-train control module (PCM) 60 (illustrated in FIG. 2) that controls the engine system 200.

The intake system IN includes an intake passage 1 though which the intake air passes. An air cleaner 3 that cleans the air introduced from the outside, a compressor of a turbocharger 5 that compresses the intake air passing therethrough to raise the intake air pressure, an intercooler 8 that cools the intake air with external air or cooling water, an intake air shut-valve 7 that adjusts the amount of intake air passing therethrough, and a surge tank 12 that temporarily stores the intake air to be supplied to the engine E are provided on the intake passage 1 in this order from the upstream to the downstream.

The intake system IN includes an air flow sensor 101 that detects an amount of intake air and an intake air temperature sensor 102 that detects the intake air temperature, the sensors 101 and 102 being provided in the direct downstream of the air cleaner 3 on the intake passage 1. An intake air pressure sensor 103 is provided to the turbocharger 5 to detect the intake air pressure. An intake air temperature sensor 106 is provided in the direct downstream of the intercooler 8 on the intake passage 1 to detect the intake air temperature. An intake air shut-valve position sensor 105 is provided to the intake air shut-valve 7 to detect the opening of the intake air shut-valve 7. An intake air pressure sensor 108 is provided to the surge tank 12 to detect the intake air pressure in the intake manifold. The sensors 101 to 108 provided in the intake system IN respectively output detection signals S101 to S108 corresponding to each detected parameter to the PCM 60.

The engine E includes an intake valve 15 for introducing the intake air supplied from the intake passage 1 (more specifically, the intake manifold) into a combustion chamber 17, a fuel injection valve (corresponding to the fuel injector of the present invention) 20 for injecting fuel in the combustion chamber 17, a piston 23 that reciprocates by the combustion of mixed gas in the combustion chamber 17, a crank shaft 25 rotated by the reciprocation of the piston 23, and an exhaust valve 27 for ejecting the exhaust gas produced by the combustion of the mixed gas in the combustion chamber 17 to an exhaust passage 41.

The fuel supply system FS includes a fuel tank 30 for storing fuel and a fuel supply passage 38 for supplying fuel from the fuel tank 30 to the fuel injection valve 20. A low pressure fuel pump 31, a high pressure fuel pump 33, and a common rail 35 are provided on the fuel supply passage 38 in this order from the upstream to the downstream.

The exhaust system EX includes the exhaust passage 41 through which the exhaust gas flows. A turbine of the turbocharger 5, a diesel oxidation catalyst (DOC) 45, and a diesel particulate filter (DPF) 46 are provided on the exhaust passage 41 in this order from the upstream to the downstream. The turbine is rotated by the exhaust gas flow to drive the compressor as described above. The DOC 45 and the DPF 46 clean the exhaust gas. The DOC 45 is a catalyst that oxidizes hydro carbon (HC) and carbon monoxide (CO) into water and carbon dioxide using oxygen in the exhaust gas. The DPF 46 is a filter that catches particulate matter (PM) in the exhaust gas.

The exhaust system EX includes an exhaust gas pressure sensor 109 provided in the upstream of the turbine of the turbocharger 5 on the exhaust passage 41 to detect the exhaust gas pressure and a linear O₂ sensor 110 provided in the direct downstream of the DPF 46 on the exhaust passage 41 to detect oxygen concentration. The sensors 109 and 110 provided in the exhaust system EX respectively output detection signals S109 and S110 corresponding to each detected parameter to the PCM 60.

The turbocharger 5 of the embodiment is a two-stage turbocharging system providing high pressure turbocharging with high efficiency throughout the speed range from the low-speed range, where exhaust energy is low, to the high-speed range. The engine system 200 includes as the turbocharger 5 a large turbocharger 5a for turbocharging a large amount of air in the high-speed range and a small turbocharger 5b capable of efficiently turbocharging air under low exhaust energy. The intake passage 1 is provided with an intake bypass passage including a compressor bypass valve 5c for controlling the intake air that flows to the compressor of the small turbocharger 5b. The exhaust passage 41 is provided with a first exhaust bypass passage including a regulating valve 5d for controlling the exhaust gas that flows to the turbine of the small turbocharger 5b and a second exhaust bypass passage including a waste gate valve 5e for controlling the exhaust gas that flows to the turbine of the large turbocharger 5a. The opening of each valve is controlled in response to the running condition of the engine E (the engine speed and the load) to select either the large turbocharger 5a or the small turbocharger 5b for turbocharging air.

The engine system 200 according to the embodiment further includes an exhaust gas recirculation (EGR) device 43. The EGR device 43 includes an EGR passage 43a connecting the exhaust passage 41 in the upstream of the turbine of the turbocharger 5 to the intake passage 1 in the downstream of the compressor of the turbocharger 5 (specifically, the downstream of the intercooler 8), and the EGR valve 43b for controlling the flow rate of the exhaust gas flowing through the EGR passage 43a.

The exhaust gas pressure in the upstream of the turbine of the turbocharger 5, the intake air pressure determined by the opening of the intake air shut-valve 7, and the opening of the EGR valve 43b substantially govern the amount of exhaust gas flow recirculated to the intake system IN by the EGR device 43 (hereinafter referred to as an EGR gas amount).

An electric scheme of the engine controller according to the embodiment of the present invention will now be described with reference to FIG. 2.

The PCM 60 (the controller of an engine equipped with a turbocharger) according to the embodiment of the present invention outputs control signals S130 to S132 to control the turbocharger 5, the fuel injection valve 20, and the EGR device 43. The control signals S130 to S132 are based, not only on the detection signals S101 to S110 from the sensors 101 to 110, but also on detection signals S97 to S100 respectively output from the accelerator position sensor 97 that detects the position of the accelerator pedal (accelerator position), a vehicle speed sensor 98 that detects the vehicle speed, an ambient temperature sensor 99 that detects the ambient temperature, and an ambient pressure sensor 100 that detects the ambient pressure.

The PCM 60 includes an acceleration input detector 61 that receives a detection signal from the accelerator position sensor 97 to detect the accelerator pedal motion (for example, the push-in amount and the push-in speed of the accelerator pedal), a fuel injection amount calculator 62 that calculates a target fuel injection amount based on the running condition of the vehicle including the accelerator pedal motion and the oxygen in the intake air to be introduced into the cylinder, a fuel injection controller 63 that controls the fuel injection valve 20 such that an amount of fuel injected by the fuel injector 20 is the target fuel injection amount, an EGR valve opening calculator 69 that calculates a controlling value for the EGR valve opening based on the running condition (the controlling value corresponds to a target EGR valve opening of the present invention), an EGR controller 64 that controls the EGR valve 43b such that the opening of the EGR valve 43b is set to the controlling value for the EGR valve opening, a delay processor 65 that delays the timing of the fuel injection controller 63 controlling fuel injection, a target engine torque calculator 66 that calculates the target engine torque based on the running condition, a smoothing processor 67 that smooths the chronologically changing target engine torque calculated by the target engine torque calculator 66, and a target oxygen concentration calculator 68 that calculates the target intake oxygen concentration in the cylinder based on the target engine torque calculated by the target engine torque calculator 66. The fuel injection amount calculator 62 has a function of setting the upper limit of the fuel injection amount (a fuel injection amount guard value Gu1, which will be described later) based on information such as oxygen concentration detected by a linear O₂ sensor 110 (the function is of the fuel injection amount limiter of the present invention).

The EGR controller 64 includes a basic EGR controller 64a that calculates the controlling value for the opening of the EGR valve 43b based on the running condition to control the opening of the EGR valve 43b when the vehicle is running at a constant speed or slowly accelerating, and an acceleration EGR controller 64b that controls the opening of the EGR valve 43b such that the opening is set smaller than the controlling value calculated by the basic EGR controller 43a when the vehicle is steeply accelerating.

The PCM 60 includes a CPU, programs executed by the CPU (including a basic control program, such as an OS, and an application program that runs on the OS to execute a particular function), a read only memory (ROM) for storing programs and data, and a computer including an embedded memory, such as a random access memory (RAM).

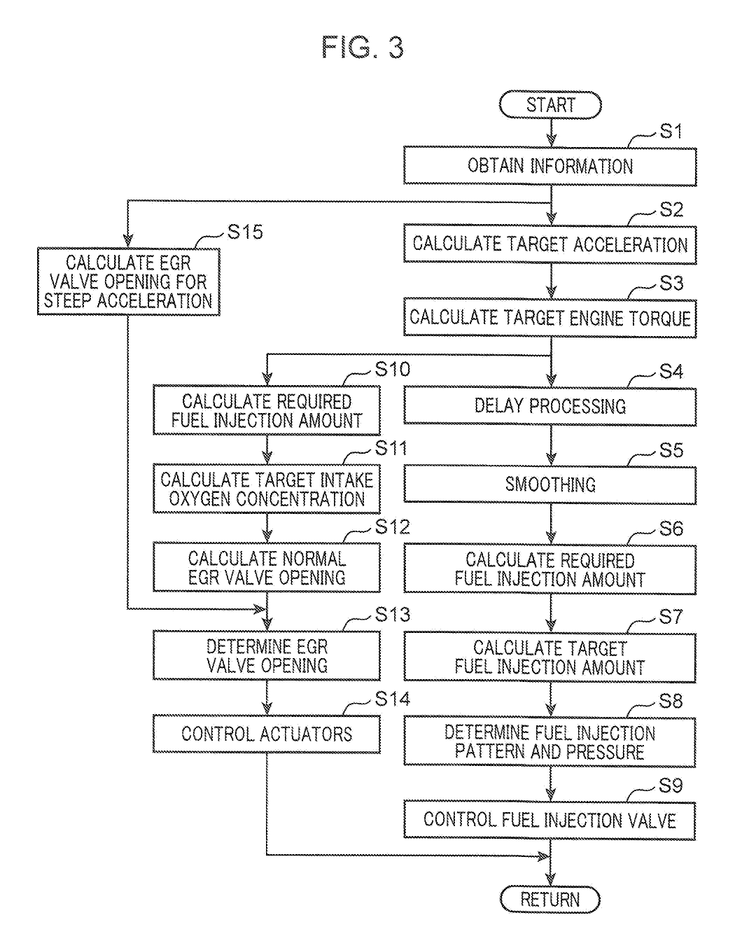

The processing performed by the engine controller will now be described with reference to FIGS. 3 to 10.

By turning on the ignition of the vehicle to power on the engine controller, the engine control processing illustrated in FIG. 3 starts and is repeatedly executed.

As illustrated in FIG. 3, after the start of the engine control processing, the PCM 60 obtains information on the running condition of the vehicle in step S1. Specifically, the PCM 60 obtains information such as the detection signals S97 to S110 output by the sensors 97 to 110, including the accelerator position (the push-in amount and the push-in speed of the accelerator pedal), the oxygen in the intake air to be introduced in the cylinder, the vehicle speed detected by the vehicle speed sensor 98, and the current gear selected in the transmission of the vehicle, as the information on the running condition.

In step S2, the target engine torque calculator 66 of the PCM 60 calculates the target acceleration based on the running condition of the vehicle including the accelerator pedal motion obtained in step S1. Specifically, the target engine torque calculator 66 selects an acceleration profile map corresponding to the current vehicle speed and gear among acceleration profile maps specified for different vehicle speeds and gears (previously prepared and stored in a memory, for example) and calculates the target acceleration corresponding to the current accelerator position with reference to the selected acceleration profile map.

In step S3, the target engine torque calculator 66 calculates the target engine torque of the engine E to achieve the target acceleration determined in step S2. The target engine torque calculator 66 calculates the target engine torque within the torque range of the engine E based on the current vehicle speed, gear, ground gradient, and friction coefficient of the ground μ, for example.

In step S4, the delay processor 65 starts the smoothing in step S5 (described later) when a predetermined time has elapsed after the completion of the target torque calculation in step S3 to delay the timing of the fuel injection controller 63 controlling fuel injection. Specifically, the delay processor 65 delays the start of the smoothing in step S5 by the time period equivalent to the difference T1-T2, where T1 is the time period between the controlling of the opening of the EGR valve 64b and the adjustment of the oxygen concentration in the cylinder, and T2 is the time period between the fuel injection valve 20 receiving an instruction of fuel injection and the actual fuel injection.

In step S5, the smoothing processor 67 smooths the chronologically changing target engine torque calculated in step S3. Specifically, known smoothing methods (for example, limiting the change rate of the target engine torque within a threshold, or calculating the moving average of the chronologically changing target engine torque) can be used for the smoothing.

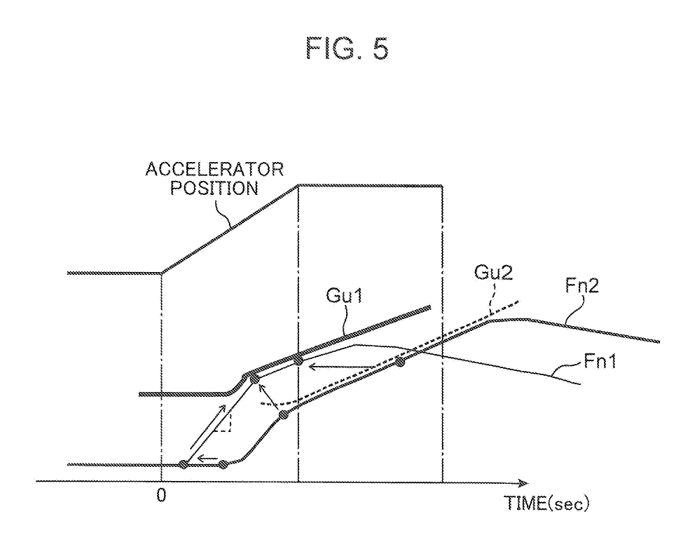

In step S6, the fuel injection amount calculator 62 calculates a required fuel injection amount based on the target engine torque smoothed in step S5 and the engine speed. In step S6, the fuel injection amount calculator 62 estimates oxygen concentration in the intake air to be introduced in the cylinder based on, for example, oxygen concentration N detected by the linear O₂ sensor 110, and calculates the upper limit of the required fuel injection amount based on the oxygen concentration. The upper limit is calculated such that the amount of produced smoke (soot) complies with an emission regulation for automobiles. The upper limit is hereinafter referred to as fuel injection amount guard value Gu1. The fuel injection amount guard value Gu1 (see FIG. 5) is set higher for a higher oxygen concentration N. For a higher oxygen concentration N in the exhaust passage 41, the higher oxygen concentration is expected in the intake air to be introduced in the cylinder and accordingly the fuel injection amount guard value Gu1 is set to a higher value.

In step S7, the fuel injection amount calculator 62 calculates a fuel injection amount to be injected by the fuel injection valve 20, that is, the target fuel injection amount, based on the required fuel injection amount calculated in step S6 and the fuel injection amount guard value Gu1. Specifically, the fuel injection amount calculator 62 compares the required fuel injection amount and the fuel injection amount guard value Gu1 and selects the smaller one as the target fuel injection amount.

In step S8, the fuel injection controller 63 sets a fuel injection pattern and a fuel pressure based on the target fuel injection amount calculated in S7 and the engine speed.

In step S9, the fuel injection controller 63 controls the fuel injection valve 20 such that the fuel injection valve 20 injects the fuel by the target fuel injection amount with the injection pattern and the fuel pressure set in step S8.

Parallel to the processing in steps S4 to S9, the fuel injection amount calculator 62 calculates in step S10 the required fuel injection amount based on the target engine torque calculated in step S3 and the engine speed. That is, the required fuel injection amount is calculated separately from the processing in step S6.

In step S11, the target oxygen concentration calculator 68 calculates the target oxygen concentration in the cylinder and the target intake air temperature based on the required fuel injection amount calculated in step S10 and the engine speed.

In step S12, the basic EGR controller 64a calculates based on the running condition the opening of the EGR valve 43b for achieving the target oxygen concentration and the target intake air temperature calculated in step S11 (referred to as an opening B12) and openings of the compressor bypass valve 5c, the regulating valve 5d, and the waste gate valve 5e.

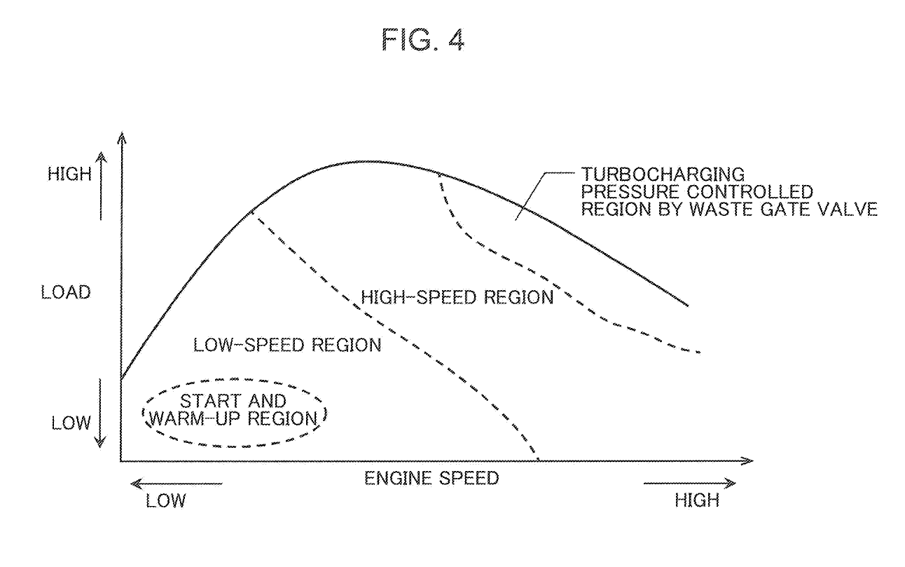

FIG. 4 is a map schematically illustrating an operating region where a large turbocharger 5a and a small turbocharger 5b selectively work. For example, when the engine E is in a running condition of start or warm-up where no turbocharging is performed by the large turbocharger 5a nor the small turbocharger 5b, the compressor bypass valve 5c, the regulating valve 5d, and the waste gate valve 5e are opened.

When the engine E is running in the low-speed region where two-stage turbocharging is performed by the large turbocharger 5a and the small turbocharger 5b, the compressor bypass valve 5c is closed, the regulating valve 5d is set between open and close based on the target turbocharging pressure, and the waste gate valve 5e is closed.

When the engine E is running in the high-speed region where single-stage turbocharging is performed by the large turbocharger 5a, the compressor bypass valve 5c and the regulating valve 5d are opened and the waste gate valve 5e is set between close and half-open corresponding to the target turbocharging pressure.

When the engine E is running in the turbocharging region regulated by the waste gate valve 5e where turbocharging is not performed or single-stage turbocharging is performed by the large turbocharger 5a, the compressor bypass valve 5c and the regulating valve 5d are opened and the waste gate valve 5e is set between close and open corresponding to the target turbocharging pressure.

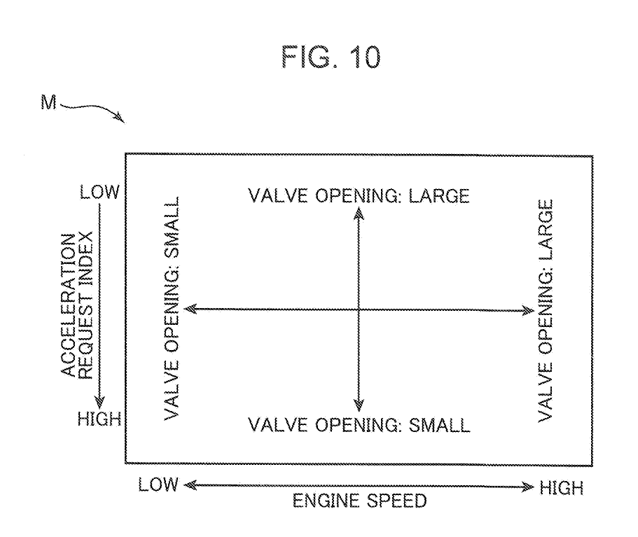

In step S15, parallel to the processing in steps S2 and S3, the acceleration EGR controller 64b selects an EGR valve opening corresponding to the current push-in amount and push-in speed of the accelerator pedal and the current engine speed from the EGR valve opening map M (previously prepared and stored in a memory, for example) illustrated in FIG. 10 and sets the selected EGR valve opening (referred to as an opening B15) as the EGR valve opening for a steep acceleration. Setting of this valve opening will specifically be described below.

The EGR valve opening map M illustrated in FIG. 10 has a vertical axis indicating an acceleration request index and the horizontal axis indicating the engine speed. The opening of the EGR valve 43b corresponding to the acceleration request index and the engine speed is determined on the EGR valve opening map M. Specifically, the acceleration request index is a digitized value representing the magnitude of acceleration required by a driver in a steep acceleration. As will be described later, the acceleration EGR controller 64b calculates the acceleration request index based on the push-in amount and the push-in speed of the accelerator pedal. A higher acceleration request index shows a stronger demand of acceleration by a driver.

In the EGR valve opening map M, the EGR valve opening is set to a larger value for a higher engine speed and to a smaller value for a larger acceleration request index. In FIG. 10, the EGR valve opening is set to the smallest value at the lower left (for example, zero, namely, full closed) and to the largest value at the upper right. The acceleration EGR controller 64b changes the opening of the EGR valve 43b in response to the accelerator pedal input (the push-in amount and the push-in speed of the accelerator pedal). The acceleration EGR controller 64b sets the EGR valve opening to a smaller value for a larger acceleration request index and to a larger value for a higher engine speed.

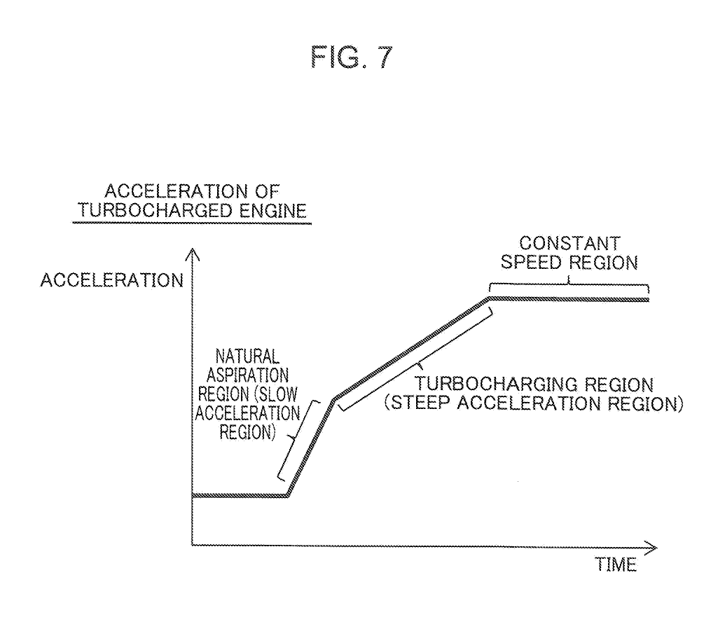

The acceleration EGR controller 64b calculates the acceleration request index based on the push-in amount and the push-in speed of the accelerator pedal and, if the calculated acceleration request index is as high as or above a predetermined value, that is, when the driver demands a steep acceleration, the acceleration EGR controller 64b calculates the opening of the EGR valve 43b. The predetermined value is the minimum value specified in the vertical axis of the EGR valve opening map M. FIG. 7 schematically illustrates the acceleration profile of the engine. The engine E given the demand of steep acceleration is in the turbocharging region illustrated in FIG. 7. The turbocharging region is the steep acceleration region where the turbocharger 5 performs turbocharging. In contrast, in region NA illustrated in FIG. 7 where acceleration is much slower than the steep acceleration region, air is taken into the cylinder by natural aspiration.

In step S13, the EGR valve opening calculator 69 determines the opening of the EGR valve. Specifically, the EGR valve opening calculator 69 compares the EGR valve opening B12 calculated in step S12 and the EGR valve opening B15 calculated in step S15 and selects the larger one as the controlling value for the EGR valve opening. If the acceleration request index is smaller than the predetermined value, the acceleration EGR controller 64b does not set the EGR valve opening. In such a case (during slow acceleration or running at a constant speed), the EGR valve opening calculator 69 determines the EGR valve opening calculated in step S12 as the controlling value.

In step S14, the basic EGR controller 64a or the acceleration EGR controller 64b controls a driving actuator of the EGR valve 43b based on the EGR valve opening determined as the controlling value in step S13. Specifically, if the EGR valve opening B12 is selected in step S13, the basic EGR controller 64a controls the opening of the EGR valve 43b such that the opening is set to the EGR valve opening B12. If the EGR valve opening B15 is selected in step S13, the acceleration EGR controller 64b controls the opening of the EGR valve 43b such that the opening is set to the EGR valve opening B15. To cause the EGR valve opening to be set to the EGR valve opening B15, the driving actuator of the EGR valve 43b is controlled in the direction to decrease the valve opening (closing direction). The processing in step S14 is started earlier than the processing in step S9.

In step S14, a turbocharger valve controller (not shown) controls the actuators of the compressor bypass valve 5c, the regulating valve 5d, and the waste gate valve 5e based on the openings of the valves 5c, 5d, and 5e calculated in step S12.

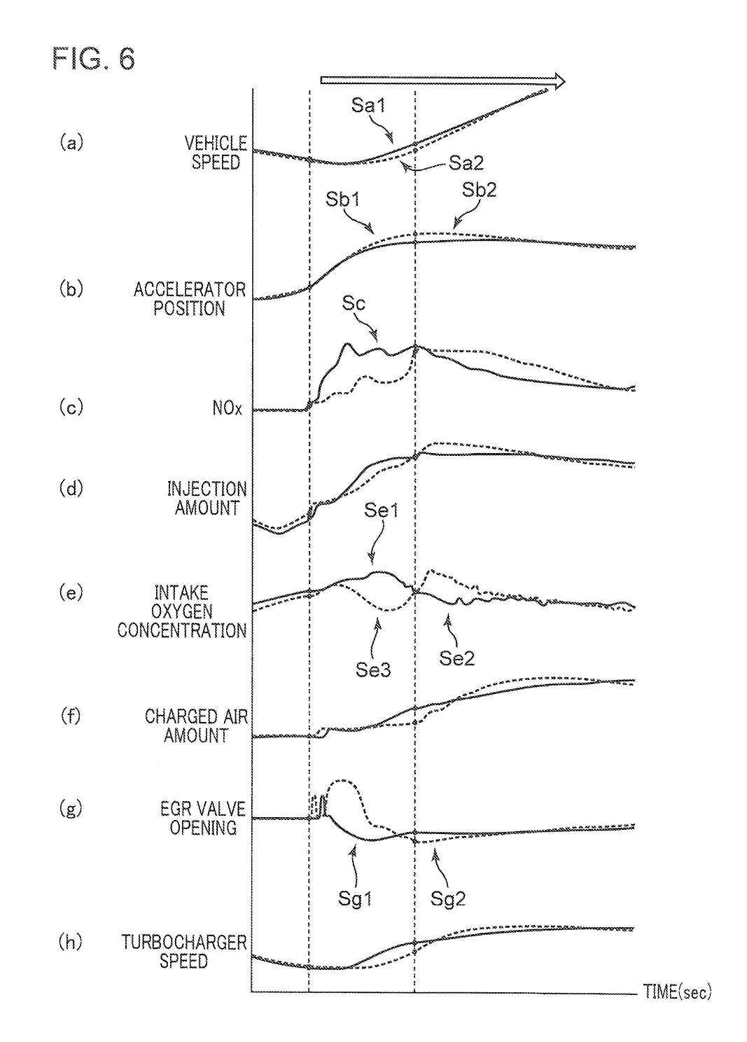

The effect provided by the embodiment will now be described with reference to FIG. 6.

FIG. 6 illustrates characteristics of the engine according to the embodiment (illustrated in solid lines) and an engine according to Comparative Example 1 (illustrated in dashed lines). The engine according to Comparative Example 1 calculates the target intake oxygen concentration based on the required fuel injection amount calculated by the processing in step S6 without performing the delay processing in step S4 and the processing in the steps S10 to S14 in FIG. 3. The engine according to Comparative Example 1 calculates the EGR valve opening (controlling value) based on the target intake oxygen concentration and controls the EGR valve based on the EGR valve opening.

As represented by the solid lines in the charts in FIG. 6, the embodiment is configured that the EGR controller 64 starts controlling the EGR valve 43b in the direction to decrease the valve opening after the accelerator pedal motion has been given but before the fuel injection controller 63 controls the fuel injection valve 20 such that the fuel injection amount is set to the target fuel injection amount corresponding to the accelerator pedal motion. This rapidly raises the oxygen concentration in the combustion chamber which, together with the rapid increase in the fuel injection amount, improves the acceleration response and also achieves the low emission performance. In the embodiment, after the accelerator pedal motion has been given (see arrow Sb1 in chart (b) in FIG. 6), the EGR valve 43b is controlled in the direction to decrease its opening (see arrow Sg1 in chart (g) in FIG. 6) based on the accelerator pedal motion to raise the oxygen concentration in the combustion chamber (see arrow Se1 in chart (e) in FIG. 6), and then the fuel injection is controlled.

Specifically, the fuel injection valve 20 needs to be controlled so as to avoid the amount of injection fuel being excessive for the oxygen concentration in the intake air, because injection of a large amount of fuel into the intake air containing insufficient amount of oxygen to be introduced in the cylinder produces soot. However, by using the EGR device 43, which recirculates the exhaust gas in the exhaust passage 41 to the intake passage 1 to supply EGR gas mixed with fresh air to the cylinder, controlling of the opening of the EGR valve 43b causes an effect with a delay, that is, the oxygen concentration in the cylinder reaches the value corresponding to the controlling value for the EGR valve opening (target EGR valve opening) with a delay after controlling the opening of the EGR valve 43b. As a result, even if the EGR valve 43b is controlled in the direction to decrease its opening immediately after the accelerator pedal motion has been given, the fuel injection amount cannot be increased until the oxygen concentration in the intake air actually rises. This deteriorates the acceleration response.

As described above, the embodiment starts controlling the opening of the EGR valve 43b, or controlling the EGR valve 43b in the direction to decrease the valve opening (see arrow Sg1 in chart (g) in FIG. 6), in response to the acceleration command given by a driver (an accelerator pedal motion (see arrow Sb1 in chart (b) in FIG. 6)), after the accelerator pedal motion has been given but before controlling the fuel injection valve 20 based on the target fuel injection amount, to rapidly increase the oxygen concentration in the combustion chamber 17 (see arrow Se1 in chart (e) in FIG. 6). This rapidly increases the fuel injection amount and thereby improves the acceleration response (see arrow Sa1 in chart (a) in FIG. 6). Although the rapid increase in the oxygen concentration in the combustion chamber 17 may produce a larger amount of NOx in the initial period after the accelerator pedal motion has been given (see arrow Sc in chart (c) in FIG. 6), the engine power rapidly reaches the power corresponding to the accelerator pedal motion, in other words, the engine E finishes the transient state within a short time and starts running in a steady state. This reduces the total amount of produced NOx. That is, the low emission performance can be achieved. As a result, the embodiment improves the acceleration response and also achieves the emission performance.

In the example illustrated in FIG. 6, the EGR valve 43b is controlled in the direction to increase its opening after the acceleration command has been given by a driver (see arrow Sb2 in chart (b) in FIG. 6) to reduce NOx (see arrow Set in chart (e) in FIG. 6). In addition to this reduction in NOx, smoke (soot) is reduced by setting the fuel injection amount guard value Gu and thus the emission performance can be achieved regarding the exhaust gas as a whole. In contrast, the engine according to the Comparative Example 1 calculates the target oxygen concentration based on the required fuel injection amount calculated by the processing in step S6 without performing the delay processing in step S4 in FIG. 3, as represented by the solid lines in the charts in FIG. 6. Thus, the EGR valve is controlled in the direction to decrease the valve opening after the accelerator pedal motion has been given and after controlling the fuel injection valve (see arrow Sg2 in chart (g) in FIG. 6). That is, the fuel is injected with a low oxygen concentration in the combustion chamber (see arrow Se3 in chart (e) in FIG. 6), which results in a slower acceleration response than the engine according to the embodiment (see arrow Sat in chart (a) in FIG. 6).

According to the embodiment, the timing of controlling the fuel injection is delayed by the delay processing S4 to surely control the opening of the EGR valve 43b earlier than controlling the fuel injection.

According to the embodiment, the chronologically changing target engine torque is smoothed in step S5 to provide smooth acceleration, which makes driving easier and also improves the acceleration response.

According to the embodiment, the target intake oxygen concentration in the cylinder is calculated based on the target engine torque in step S11, and the opening of the EGR valve 43b is controlled to adjust the oxygen concentration in the combustion chamber 17 to the target intake oxygen concentration. Thus, the control of the opening of the EGR valve 43b (the processing in step S14) is surely performed at a timing earlier than the timing of the fuel injection control (the processing in step S9). That is, the control of the opening of the EGR valve 43b (the processing in step S14) is performed without the smoothing of the chronologically changing target engine torque (the processing in step S5), so that the control of the opening of the EGR valve 43b is performed at an earlier timing. As a result, the control of the opening of the EGR valve 43b is surely performed at a timing earlier than the timing of the fuel injection control (the processing in step S9).

If the embodiment is used in an engine that limits the fuel injection amount, the opening of the EGR valve 43b can be controlled at an earlier timing to raise the upper limit of the fuel injection amount (fuel injection amount guard value Gu1) at an earlier timing.

For example, FIG. 5 schematically illustrates the relationship among the accelerator pedal input (accelerator position) during acceleration, the fuel injection amount guard value, and the fuel injection amount. Gu1 is the fuel injection amount guard value set in the embodiment, and Gut is the fuel injection amount guard value set in Comparative Example 1. Fn1 is the fuel injection amount in the embodiment, and Fn2 is the fuel injection amount in Comparative Example 1. As illustrated in FIG. 5, the embodiment controls the opening of the EGR valve 43b at an earlier timing to set the fuel injection amount guard value Gu1 to a higher value in the early stage of the accelerator pedal motion (increase in the accelerator position). This increases the fuel injection amount in the earlier stage to improve the acceleration response.

In contrast, the engine according to the Comparative Example 1 calculates the target oxygen concentration based on the required fuel injection amount calculated by the processing in step S6 without performing the delay processing in step S4 in FIG. 3, which results in a slow increase in the oxygen concentration in the cylinder. This slows the rise in the fuel injection amount guard value Gut as well as the increase in the fuel injection amount Fn2. As a result, the acceleration response is worse than that in the embodiment.

The embodiment is particularly useful for the engine E including the turbocharger 5. Specifically, by starting the control of the opening of the EGR valve 43b in response to the acceleration command given by a driver (changing the valve opening to a relatively small value) before controlling the fuel injection, fuel is injected after the oxygen concentration in the combustion chamber 17 has been adjusted to the oxygen concentration corresponding to the acceleration command given by the driver. This creates combustion in the combustion chamber 17 corresponding to the acceleration command given by the driver, and thereby favorably increases the flow rate of exhaust gas and the rotational speed of the turbocharger 5. As a result, the acceleration required by the driver can be obtained, namely, the acceleration response is improved.

The embodiment can provide an effect described below.

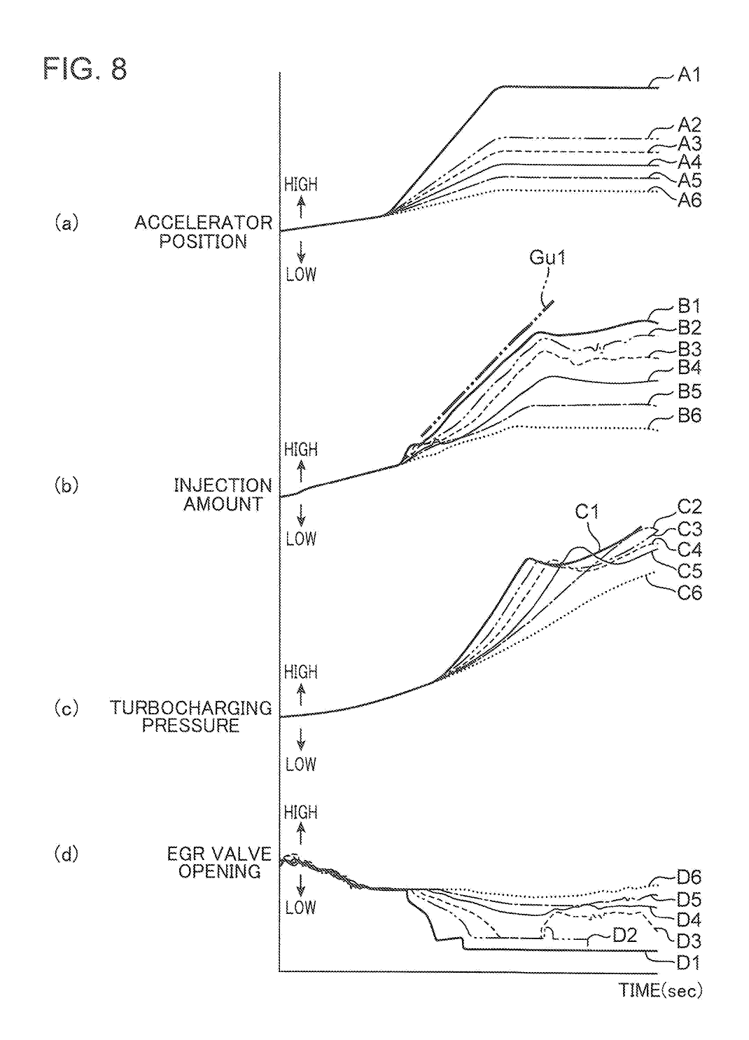

Lines A1 to A6 in chart (a) in FIG. 8 represent six patterns of the change in accelerator position of an embodiment including the acceleration EGR controller 64b. Line A1 represents the largest accelerator position. The accelerator position becomes smaller in the order of A2 to A6. In FIG. 8, lines B1 to B6 in chart (b) represent the fuel injection amount respectively corresponding to lines A1 to A6 representing the acceleration position. Lines C1 to C6 in chart (c) represent turbocharging pressure respectively corresponding to lines A1 to A6. Lines D1 to D6 in chart (d) represent the EGR valve opening respectively corresponding to lines A1 to A6.

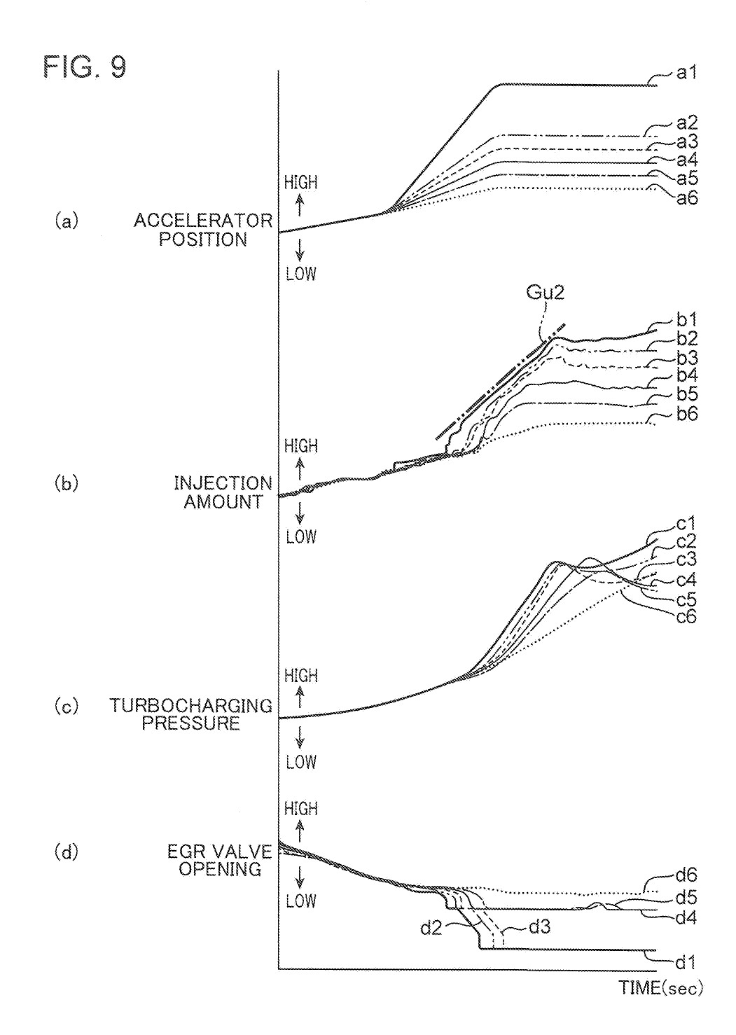

Lines a1 to a6 in chart (a) in FIG. 9 represent six patterns of the change in accelerator position of an engine that does not include the acceleration EGR controller 64b (hereinafter referred to as Comparative Example 2). Line a1 represents the largest accelerator position. The accelerator position becomes smaller in the order of a2 to a6. In FIG. 9, lines b1 to b6 in chart (b) represent the fuel injection amount respectively corresponding to lines a1 to a6 representing the acceleration position. Lines c1 to c6 in chart (c) represent the turbocharging pressure respectively corresponding to lines a1 to a6. Lines d1 to d6 in chart (d) represent EGR valve opening respectively corresponding to lines a1 to a6.

In the embodiment as described above, the acceleration EGR controller 64b sets the EGR valve opening to a smaller opening than the EGR valve opening calculated by the basic EGR controller 64a. This sets the amount of EGR gas supplied to the cylinder during a steep acceleration to be set smaller than the amount supplied during a constant speed running and a slow acceleration. Supplying a smaller amount of EGR gas causes the oxygen concentration in the cylinder to be relatively high. High oxygen concentration in the cylinder allows the increase in the fuel injection amount, thereby thrusting the vehicle with a steeper acceleration.

Moreover, the acceleration EGR controller 64b changes the EGR valve opening in response to the accelerator pedal input (see chart (a) and chart (d) in FIG. 8), in other words, the EGR valve opening is set to different values for different accelerator pedal inputs. The oxygen concentration in the cylinder is changed for different accelerator pedal inputs to change the fuel injection amount (see chart (b) in FIG. 8). Thus, the vehicle acceleration is further correctly changed in response to the accelerator pedal input. Consequently, the acceleration response corresponding to the requested driving force can be obtained during a steep acceleration.

More specifically, during a steep acceleration, the acceleration EGR controller 64b sets a relatively large EGR valve opening for a relatively low acceleration, and a relatively small EGR valve opening for a relatively high acceleration (quick acceleration). The EGR valve opening is controlled not to a small value when acceleration is relatively low even during a steep acceleration, so that the EGR valve opening can be caused to decrease as the acceleration steeply rises. This allows a change in the oxygen concentration in the cylinder and increasing the fuel injection amount. Moreover, changing the amount of EGR gas supplied to the cylinder in response to the accelerator pedal input avoids reducing the amount of supplied EGR gas to such a small amount as to produce NOx. Consequently, the low emission performance can be achieved.

As illustrated in chart (b) in FIG. 8, the embodiment is particularly effective when the fuel injection amount guard value Gu1 is set. If the fuel injection amount guard value Gu1 is set, and when an acceleration command exceeding the guard value Gu1 is given, the acceleration response corresponding to the requested driving force can be obtained. Even when such an acceleration command exceeding the performance limit of the turbocharger 5 is given, the acceleration response corresponding to the requested driving force can be obtained by a similar effect.

In contrast, for an engine according to Comparative Example 2 not including the acceleration EGR controller 64b, if the fuel injection amount guard value Gu2 is set, and when an acceleration command exceeding the fuel injection amount guard value Gu2 is given, the fuel injection amount is fixed to the fuel injection amount guard value Gu2 regardless of any change in the acceleration command. Thus, the acceleration response corresponding to the requested driving force cannot be obtained (see chart (b) in FIG. 9).

The embodiment is such that the acceleration of the vehicle responding to the accelerator pedal motion can surely be improved by using the push-in amount and the motion speed of the accelerator pedal, each of which reflecting the acceleration command given by the driver, as parameters representing the acceleration command.

The embodiment is such that the acceleration EGR controller 64b sets the opening of the EGR valve 43b to a larger value for a higher engine speed. This minimizes a significant change in the amount of oxygen flowing into the cylinder in a unit time between before and after the increase of the opening of the EGR valve 43b. Thus, the change in the vehicle acceleration caused by the change in the engine speed can be minimized.

As described above, the embodiment used in the engine E including the turbocharger 5 has another advantage that the oxygen concentration in the cylinder can further efficiently be changed for different accelerator pedal inputs. That is, the engine E including the turbocharger 5 is such that the change in the opening of the EGR valve 43b made to change the oxygen concentration in the cylinder causes the change in the amount of supplied EGR gas and thereby changes the amount of exhaust gas introduced to the turbine of the turbocharger 5. The change in the amount of exhaust gas introduced to the turbine causes the change in the work done by the compressor, which results in the change in the amount of oxygen introduced to the cylinder. This is advantageous in changing the oxygen concentration in the cylinder in response to the change in the running condition.

More specifically, for example, during a steep acceleration using the turbocharger 5, when acceleration is relatively low and the opening of the EGR valve 43b is relatively large, the amount of supplied EGR gas increases and the amount of exhaust gas introduced to the turbine decreases. With a small amount of exhaust gas introduced to the turbine, the work done by the compressor is small and thus the amount of oxygen supplied to the cylinder is small (the amount of supplied oxygen becomes smaller than the amount of oxygen that the compressor can supply to the cylinder under the current running condition). Then, when acceleration increases to become relatively high (quick acceleration) during the steep acceleration, the EGR valve 43b is controlled so as to decrease its opening to reduce the amount of supplied EGR gas, thereby raising the oxygen concentration in the cylinder. The decrease in the amount of supplied EGR gas increases the amount of exhaust gas introduced to the turbine, and thereby the work done by the compressor increases to raise the amount of oxygen supplied in the cylinder. As a result, the amount of oxygen supplied to the cylinder further rises. Accordingly, the engine E including the turbocharger 5 can further significantly change the amount of oxygen supplied to the cylinder to further effectively change the acceleration of the vehicle in response to the change in the running condition. This is realized by changing the opening of the EGR valve to change the work done by the compressor to create a further significant change in the amount of oxygen supplied to the cylinder.

The engine E including the turbocharger 5 is such that the acceleration EGR controller 64b increases the amount of oxygen supplied to the cylinder to increase the fuel injection amount, which thereby increases the exhaust gas flow at an earlier timing to make the turbocharger 5 achieve its performance at an earlier timing to improve the acceleration response.

The acceleration EGR controller 64b calculates the opening of the EGR valve 43b directly from the accelerator pedal input, which is faster than the basic EGR controller 64a calculating the opening of the EGR valve 43b. This improves the acceleration response.

The embodiment described above is an example of a preferable embodiment of the present invention. Specific configuration may be changed as required without departing from the spirit and scope of the present invention.

For example, the described embodiment applied to the diesel engine can also be applied to the gasoline engine.

The embodiment may not perform the smoothing (step S5 in FIG. 3). In such a case, for example, the acceleration response can be improved by extending the delay time in the delay processing in step S4.

The embodiment may not perform the calculation of the EGR valve opening for a steep acceleration in step S15 in FIG. 3. In this case, the acceleration response can be improved as well.

The present invention can be summarized as follows.

The present invention provides an engine controller for controlling, based on a running condition of a vehicle, an engine including an EGR device that includes an EGR passage for recirculating exhaust gas in an exhaust passage to an intake passage and an EGR valve for adjusting a flow rate of exhaust gas flowing through the EGR passage, and a fuel injector that injects fuel in a cylinder. The engine controller includes an acceleration input detector that detects an accelerator pedal motion, a fuel injection amount calculator that calculates a target fuel injection amount based on a running condition of the vehicle including the accelerator pedal motion and oxygen in an intake air to be introduced in the cylinder, a fuel injection controller that controls the fuel injector such that an amount of fuel injected by the fuel injector is the target fuel injection amount, an EGR valve opening calculator that calculates a target EGR valve opening based on the running condition, and an EGR controller that controls the EGR valve such that an opening of the EGR valve is set to the target EGR valve opening. The EGR controller starts controlling the EGR valve in a direction to decrease the opening of the EGR valve to the target EGR valve opening corresponding to a running condition to be reached after the accelerator pedal motion has been given, the controlling of the opening of the EGR valve being started after the accelerator pedal motion has been given but before the fuel injection controller controls the fuel injector based on the target fuel injection amount calculated by the fuel injection amount calculator based on the accelerator pedal motion.

According to the present invention, the EGR controller starts controlling the EGR valve in the direction to decrease its opening after the accelerator pedal motion has been given but before the fuel injection controller controls the fuel injector such that the fuel injection amount is set to a target fuel injection amount corresponding to the accelerator pedal motion. This rapidly raises the oxygen concentration in the combustion chamber which, together with the rapid increase in the fuel injection amount, improves the acceleration response and also achieves the low emission performance as a whole.

Specifically, the fuel injection valve needs to be controlled to avoid the amount of injection fuel being excessive for the oxygen concentration in the intake air, because injection of a large amount of fuel into the intake air containing insufficient amount of oxygen to be introduced in the cylinder produces soot. However, by using the EGR device, which recirculates the exhaust gas in the exhaust passage to the intake passage to supply EGR gas mixed with fresh air to the cylinder, controlling (adjusting) of the opening of the EGR valve causes an effect with a delay, that is, the oxygen concentration in the cylinder reaches the value corresponding to the target EGR valve opening with a delay after controlling the opening of the EGR valve. As a result, even if the EGR valve is controlled in the direction to decrease its opening immediately after the accelerator pedal motion has been given, the fuel injection amount cannot be increased until the oxygen concentration in the intake air actually rises. This deteriorates the acceleration response.

As described above, the embodiment of the present invention starts controlling the opening of the EGR valve (controlling the valve in the direction to decrease its opening) in response to the acceleration command given by a driver (the accelerator pedal motion), after the accelerator pedal motion has been given but before controlling the fuel injector based on the target fuel injection amount, to rapidly increase the oxygen concentration in the combustion chamber. This rapidly increases the fuel injection amount and thereby improves the acceleration response.

Although the rapid increase in the oxygen concentration in the combustion chamber may produce a large amount of NOx in the initial period after the accelerator pedal motion has been given, the engine power rapidly reaches the power corresponding to the accelerator pedal motion, in other words, the engine finishes the transient state within a short time and starts running in a steady state. This reduces the total amount of produced NOx. That is, the low emission performance can be achieved. As a result, the embodiment of the present invention improves the acceleration response and also achieves the emission performance.

In the embodiment of the present invention, the EGR controller preferably controls the opening of the EGR valve in parallel with processing of calculating the target fuel injection amount performed by the fuel injection amount calculator, the opening of the EGR valve being controlled after the acceleration input detector has detected the accelerator pedal motion.

Such a configuration, controlling the EGR valve opening in parallel with the processing of calculating the target fuel injection amount after detecting the accelerator pedal motion, can easily control the opening of the EGR valve at a timing earlier than controlling the fuel injection.

The embodiment of the present invention preferably includes a delay processor that delays a timing of the fuel injection controller controlling fuel injection.

Such a configuration, delaying the timing of fuel injection control by the delay processing, surely enables controlling the EGR valve opening at a timing earlier than controlling the fuel injection.

The embodiment of the present invention preferably further includes a target engine torque calculator that calculates a target engine torque based on the running condition, and a smoothing processor that smooths a chronologically changing target engine torque calculated by the target engine torque calculator. The fuel injection amount calculator calculates a fuel injection amount based on the target engine torque smoothed by the smoothing processor.

Such a configuration, smoothing the chronologically changing target engine torque, can provide a smooth acceleration to make driving easy (provide drivability). Thus, the ease of driving and the acceleration response can both be achieved.

The embodiment of the present invention preferably further includes a target oxygen concentration calculator that calculates a target intake oxygen concentration in the cylinder based on the target engine torque calculated by the target engine torque calculator. The EGR controller controls the opening of the EGR valve such that an oxygen concentration in a combustion chamber is a target oxygen concentration calculated by the target oxygen concentration calculator.

Such a configuration, calculating the target intake oxygen concentration in the cylinder based on the target engine torque and controlling the EGR valve opening such that the oxygen concentration in the combustion chamber is the target oxygen concentration, surely enables the EGR valve opening to be controlled at a timing earlier than controlling the fuel injection. Specifically, the control of fuel injection performed by the fuel injection controller includes a step of smoothing the chronological changing target engine torque and a step of calculating the fuel injection amount based on the smoothed target engine torque. Meanwhile, this configuration controls the EGR valve opening without the step of smoothing the chronologically changing target engine torque, so that the EGR valve opening is controlled at an earlier timing, thereby surely controlling the EGR valve opening earlier than controlling the fuel injection.

The embodiment of the present invention is particularly useful for an engine including the fuel injection amount calculator includes a fuel injection amount limiter that sets an upper limit of the target fuel injection amount based on an oxygen concentration in an exhaust passage of the engine.

Specifically, the fuel injection amount limiter sets the upper limit of the target fuel injection amount to prevent emission of exhaust gas from an engine entailing a large amount of smoke (soot). Such an engine including the fuel injection amount limiter however limits the fuel injection amount during acceleration of a vehicle, which might deteriorate the acceleration response. By using the embodiment of the present invention in the engine including the fuel injection amount limiter, the EGR valve opening can be controlled at an earlier timing to raise the upper limit of the fuel injection amount. The limit on the fuel injection can thus be avoided and the acceleration response can be improved.

An engine controller according to another embodiment of the present invention for controlling, based on a running condition of a vehicle, an engine including an EGR device that includes an EGR passage for recirculating exhaust gas in an exhaust passage to an intake passage and an EGR valve for adjusting a flow rate of exhaust gas flowing through the EGR passage, and a fuel injector that injects fuel in a cylinder. The engine controller includes a fuel injection amount calculator that calculates a target fuel injection amount based on a running condition of a vehicle including an accelerator pedal motion, a fuel injection controller that controls the fuel injector such that an amount of fuel injected by the fuel injector is the target fuel injection amount, a basic EGR controller that calculates an opening of the EGR valve based on the running condition and controls the opening of the EGR valve when the vehicle runs at a constant speed, and an acceleration EGR controller that controls the opening of the EGR valve such that the opening is set smaller than a controlling value calculated by the basic EGR controller when the vehicle is in acceleration. The acceleration EGR controller changes the opening of the EGR valve in response to the accelerator pedal motion.

In the present invention, the condition of the vehicle running at a constant speed includes both the vehicle running at a constant speed and the vehicle accelerating with a relatively low acceleration above zero (slow acceleration). The condition of the vehicle accelerating means that the vehicle accelerates with acceleration higher than the slow acceleration.

According to the embodiment of the present invention, the acceleration EGR controller sets the EGR valve opening to a value smaller than the EGR valve opening calculated by the basic EGR controller (controlling value). The amount of EGR gas supplied to the cylinder is thereby set smaller than the amount supplied to run the vehicle at a constant speed and accelerate with a slow acceleration, and thus the oxygen concentration in the cylinder becomes relatively high. The amount of injected fuel can be increased as the oxygen concentration in the cylinder rises, thereby thrusting the vehicle with a steep acceleration. The acceleration EGR controller changes the EGR valve opening in response to different accelerator pedal inputs, that is, the EGR valve opening is set to different values for different accelerator pedal inputs. The oxygen concentration in the cylinder is thereby changed for different accelerator pedal inputs, and the fuel injection amount is changed in response to the change in the oxygen concentration. Thus, the acceleration of the vehicle significantly changes in response to the accelerator pedal input. Accordingly, the acceleration response corresponding to the requested driving force can be obtained during a steep acceleration.

More specifically, the acceleration EGR controller sets the EGR valve opening, during steep acceleration, to a relatively large value for a relatively low acceleration but to a relatively small value for a relatively high acceleration (quick acceleration). That is, even during a steep acceleration, the EGR valve opening is not set to a small value when the acceleration is relatively low, so that the EGR valve opening can be caused to decrease as the acceleration steeply rises. This allows the change in the oxygen concentration in the cylinder and the increase in the fuel injection amount. Moreover, changing the amount of EGR gas supplied to the cylinder in response to the accelerator pedal input avoids reducing the amount of supplied EGR gas to such a small amount as to produce NOx. Consequently, the low emission performance can be achieved.

The embodiment of the present invention is preferably configured that the acceleration EGR controller sets the opening of the EGR valve to a relatively smaller value for a relatively larger requested driving force determined based on the accelerator pedal motion.

Setting the EGR valve opening to a relatively small value raises the oxygen concentration in the air supplied to the cylinder to a relatively high value. This allows the increase in the fuel injection amount, which further surely improves the acceleration response.

In the embodiment of the present invention, the accelerator pedal motion is preferably a distance and a speed of a motion of the accelerator pedal.

The push-in amount and the speed of the motion of the accelerator pedal reflect the acceleration command given by a driver. Setting these values as parameters representing the acceleration command surely improves the vehicle acceleration responding to the accelerator pedal motion.

In the embodiment of the present invention, the acceleration EGR controller preferably sets the opening of the EGR valve to a larger value for a higher engine speed.

Since a larger amount of air flows into the cylinder in a unit time for a higher engine speed, a significant change in the amount of oxygen flowing into the cylinder in a unit time between before and after the increase of the opening of the EGR valve can be minimized. Thus, the change in the vehicle acceleration caused by the change in the engine speed can be avoided.

The embodiment of the present invention further includes a target engine torque calculator that calculates a target engine torque based on the accelerator pedal motion. The basic EGR controller controls the opening of the EGR valve based on the target engine torque calculated by the target engine torque calculator.

The acceleration EGR controller, calculating the EGR valve opening directly from the accelerator pedal motion, calculates the EGR valve opening at an earlier timing than the basic EGR controller, thereby improving the acceleration response.

The embodiment of the present invention is particularly useful for an engine including a turbocharger.

The present invention can be used in an engine including a turbocharger to further efficiently change the oxygen concentration in the cylinder for different accelerator pedal inputs. In the engine including a turbocharger, changing the EGR valve opening to change the oxygen concentration in the cylinder causes a change in the amount of supplied EGR gas, which changes the amount of exhaust gas introduced to the turbine of the turbocharger. The change in the amount of exhaust gas introduced to the turbine causes the change in the work done by the compressor, resulting in the change in the amount of oxygen supplied to the cylinder. This is advantageous in creating a change in the oxygen concentration in the cylinder in response to the change in the running condition.

More specifically, for example, during a steep acceleration using the turbocharger, when the acceleration is relatively low and the opening of the EGR valve is relatively large, a large amount of EGR gas is supplied and a small amount of exhaust gas is introduced to the turbine. With a small amount of exhaust gas introduced to the turbine, the work done by the compressor is small and thus the amount of oxygen supplied to the cylinder is small (the amount of supplied oxygen becomes smaller than the amount of oxygen that the compressor can supply to the cylinder under the current running condition). Then, with a relatively high acceleration (quick acceleration) taking place during the steep acceleration, the opening of the EGR valve is caused to decrease to reduce the amount of supplied EGR gas, thereby raising the oxygen concentration in the cylinder. The decrease in the amount of supplied EGR gas increases the amount of exhaust gas introduced to the turbine, and thereby the work done by the compressor increases to raise the amount of oxygen supplied to the cylinder. As a result, the amount of oxygen supplied to the cylinder rises more. Accordingly, the engine including a turbocharger can further significantly change the amount of oxygen supplied to the cylinder to further effectively change the acceleration of the vehicle in response to the change in the running condition. This is realized by changing the opening of the EGR valve to change the work done by the compressor to create a further significant change in the amount of oxygen supplied to the cylinder.

The engine including the turbocharger is such that the acceleration EGR controller increases the amount of oxygen supplied to the cylinder to increase the fuel injection amount, which thereby increases the exhaust gas flow at an earlier timing to make the turbocharger achieve its performance at an earlier timing. The acceleration response can thus be improved.

The embodiment of the present invention is particularly useful for an engine further including at least one turbocharger.

The embodiment of the present invention can be used in the engine including a plurality of turbochargers to make each turbocharger achieve its performance at an early timing to further improve the acceleration response.

This application is based on Japanese Patent Application No. 2016-025048 and No. 2016-025056 filed in Japan Patent Office on Feb. 12, 2016, the contents of which are hereby incorporated by reference.

Although the present invention has been fully described by way of example with reference to the accompanying drawings, it is to be understood that various changes and modifications will be apparent to those skilled in the art. Therefore, unless otherwise such changes and modifications depart from the scope of the present invention hereinafter defined, they should be construed as being included therein.

1. An engine controller for controlling, based on a running condition of a vehicle, an engine including an EGR device that includes an EGR passage for recirculating exhaust gas in an exhaust passage to an intake passage and an EGR valve for adjusting a flow rate of exhaust gas flowing through the EGR passage, and a fuel injector that injects fuel in a cylinder, the engine controller comprising:
an acceleration input detector that detects an accelerator pedal motion;
a fuel injection amount calculator that calculates a target fuel injection amount based on a running condition of the vehicle including the accelerator pedal motion and oxygen in an intake air to be introduced in the cylinder;
a fuel injection controller that controls the fuel injector such that an amount of fuel injected by the fuel injector is the target fuel injection amount;
an EGR valve opening calculator that calculates a target EGR valve opening based on the running condition; and
an EGR controller that controls the EGR valve such that an opening of the EGR valve is set to the target EGR valve opening,
wherein the EGR controller starts controlling the EGR valve in a direction to decrease the opening of the EGR valve to the target EGR valve opening corresponding to a running condition to be reached after the accelerator pedal motion has been given, the controlling of the opening of the EGR valve being started after the accelerator pedal motion has been given but before the fuel injection controller controls the fuel injector based on the target fuel injection amount calculated by the fuel injection amount calculator based on the accelerator pedal motion.

2. The engine controller according to claim 1, wherein
the EGR controller controls the opening of the EGR valve in parallel with processing of calculating the target fuel injection amount performed by the fuel injection amount calculator, the opening of the EGR valve being controlled after the acceleration input detector has detected the accelerator pedal motion.

3. The engine controller according to claim 1, further comprising a delay processor that delays a timing of the fuel injection controller controlling fuel injection.

4. The engine controller according to claim 1, further comprising:
a target engine torque calculator that calculates a target engine torque based on the running condition; and
a smoothing processor that smooths a chronologically changing target engine torque calculated by the target engine torque calculator,
wherein the fuel injection amount calculator calculates a fuel injection amount based on the target engine torque smoothed by the smoothing processor.

5. The engine controller according to claim 4, further comprising a target oxygen concentration calculator that calculates a target intake oxygen concentration in the cylinder based on the target engine torque calculated by the target engine torque calculator,
wherein the EGR controller controls the opening of the EGR valve such that an oxygen concentration in a combustion chamber is a target oxygen concentration calculated by the target oxygen concentration calculator.

6. The engine controller according to claim 1, wherein
the fuel injection amount calculator includes a fuel injection amount limiter that sets an upper limit of the target fuel injection amount based on an oxygen concentration in an exhaust passage of the engine.

7. An engine controller for controlling, based on a running condition of a vehicle, an engine including an EGR device that includes an EGR passage for recirculating exhaust gas in an exhaust passage to an intake passage and an EGR valve for adjusting a flow rate of exhaust gas flowing through the EGR passage, and a fuel injector that injects fuel in a cylinder, the engine controller comprising:
a fuel injection amount calculator that calculates a target fuel injection amount based on a running condition of a vehicle including an accelerator pedal motion;
a fuel injection controller that controls the fuel injector such that an amount of fuel injected by the fuel injector is the target fuel injection amount;
a basic EGR controller that calculates an opening of the EGR valve based on the running condition and controls the opening of the EGR valve when the vehicle runs at a constant speed; and
an acceleration EGR controller that controls the opening of the EGR valve such that the opening is set smaller than a controlling value calculated by the basic EGR controller when the vehicle is in acceleration,
wherein the acceleration EGR controller changes the opening of the EGR valve in response to the accelerator pedal motion.

8. The engine controller according to claim 7, wherein
the acceleration EGR controller sets the opening of the EGR valve to a relatively smaller value for a relatively larger requested driving force determined based on the accelerator pedal motion.

9. The engine controller according to claim 8, wherein the accelerator pedal motion is a distance and a speed of a motion of the accelerator pedal.

10. The engine controller according to claim 7, wherein the acceleration EGR controller sets the opening of the EGR valve to a larger value for a higher engine speed.

11. The engine controller according to claim 7, further comprising a target engine torque calculator that calculates a target engine torque based on the accelerator pedal motion,
wherein the basic EGR controller controls the opening of the EGR valve based on the target engine torque calculated by the target engine torque calculator.

12. The engine controller according to claim 1, wherein the engine includes a turbocharger.

13. The engine controller according to claim 12, further comprising at least one turbocharger.

14. The engine controller according to claim 7, wherein the engine includes a turbocharger.

15. The engine controller according to claim 14, further comprising at least one turbocharger.
